(19) United States
(12) Patent Application Publication
(10) Pub. No.: US 2017/0050263 A1
(43) Pub. Date: Feb. 23, 2017

(54) FRICTION STIR WELDING DEVICE AND METHOD OF FRICTION STIR WELDING

(71) Applicant: Amulaire thermal technology, INC., New Taipei City (TW)

(72) Inventors: CHUN-LUNG WU, New Taipei City (TW); MING-SIAN LIN, New Taipei City (TW); WEN-YUAN CHOU, New Taipei City (TW)

(21) Appl. No.: 14/833,007

(22) Filed: Aug. 21, 2015

(51) Int. Cl. B23K 20/12

(52) U.S. Cl. CPC B23K 20/1245

(57) ABSTRACT

A friction stir welding device, provided for welding stacked metallic boards together, includes a mounting seat and a plurality of friction-stir tools. The mounting seat is defined with a rotational axis-direction. Each friction-stir tool has a shoulder portion and a stirring probe protruded from the shoulder portion. The friction-stir tools are arranged in the rotational axis-direction and disposed on a bottom surface of the mounting seat. The friction-stir tools can rotate along the rotational axis-direction. When a relative linear motion is applied between the friction-stir tools and the stacked metallic boards, the shoulders of the friction-stir tools produce stirring-coverage zones which are overlapped partially along the linear movement direction, so that the stirring-coverage zones by the friction-stir tools form a planar welding zone. The present disclosure also provides a method of friction stir welding for welding stacked metallic boards together.

### BACKGROUND OF THE INVENTION

1. Field of the Invention

The present invention is related to a friction stir welding device. In particular, the present invention relates to a device utilizing friction stir welding technology (FSW technology) to weld two stacked metallic boards together. In addition, a method of friction stir welding is provided to weld the stacked metallic boards.

2. Description of Related Art

To weld two stacked metallic boards together is widely applied in many industry technology fields. Especially, if two metallic boards of different materials are welded, the characteristics of two different kinds of metal materials can provide a complementary efficiency. To take the heat-dissipating field as an example, a copper alloy board combined with an aluminum alloy board can enhance the performance of thermal conductivity. In the automotive industry, aluminum strengthening posts combined with a magnesium alloy panel can increase the structural strength.

The friction stir welding (FSW) method has been gradually applied to weld the two stacked metallic boards. Friction stir welding has a friction-stir tool rotating at a high constant rate. The friction-stir tool includes a shoulder portion and a stirring probe protruded from the shoulder portion. The shoulder portion is used to frictionally contact a processing workpiece until generating heat energy. The stirring probe is inserted into the processing workpiece for rubbing, stirring and mixing. When the friction-stir tool is rotating at a high rate and applies downward pressure upon the processing workpiece along an axial direction, frictional heat is generated by the mechanical mixing process between the two metallic boards to cause the stirred materials to soften without melting (plastic deformation). The friction-stir tool traverses slowly and rotates continuously for friction stirring, so as to joint two metallic boards.

The friction stir welding can be applied along the contiguous edges of two processing work-pieces for welding, or applied on the top surface of an upper workpiece to join a lower workpiece. The friction stir welding further includes the method of Friction Stir Spot Welding (FSSW) to provide a spot welding. When a welding process is applied to two stacked metallic boards, the metallic boards are welded only in a spot manner by the FSSW method, or only welded on edges of the metallic boards. Under such welding conditions, two metallic boards are not truly jointed, because gaps exist therebetween which affect the efficiency of thermal conductivity. A conventional way may weld linearly using the friction-stir tool in a traverse manner, and then turn to process another linear welding, until forming a reciprocating zigzag-shaped welding condition. Such a welding manner not only costs much time, but also two contiguous linear welding portions may not be jointed well.

### SUMMARY OF THE INVENTION

It is one objective of this invention to provide a friction stir welding device to make facing surfaces of stacked metallic boards be jointed in a planar manner, so as to reduce gaps between the metallic boards.

In order to achieve the above objectives, the present invention provides a friction stir welding device, for welding stacked metallic boards. The friction stir welding device includes a linking seat and a plurality of friction-stir tools. The linking seat is defined with a rotational axis-direction. Each of the friction-stir tools has a shoulder portion and a stirring probe protruded from the shoulder portion. The friction-stir tools are arranged in the rotational axis-direction under the linking seat. The friction-stir tools are rotatable in the rotational axis-direction. When a relative linear motion happens between the friction-stir tools and the stacked metallic boards, the shoulder portion of the friction-stir tools produces stirring-coverage zones partially overlapped in the linear moving direction, so that the stirring-coverage zones by the friction-stir tools form a planar welding zone.

In addition, a further objective of this invention is to provide a method of friction stir welding, used to weld stacked metallic boards, comprising steps as follows:

providing a linking seat, and defining a rotational axis-direction in the linking seat;

providing a plurality of friction-stir tools, and connecting the friction-stir tools to the linking seat in a parallel manner and being rotatable in the rotational axis-direction, wherein each of friction-stir tools has a shoulder portion and a stirring probe protruded from the shoulder portion;

making relative linear motions between the friction-stir tools the stacked metallic boards; and

arranging stirring-coverage zones produced by the shoulder portions of the friction-stir tools being overlapped partially to each other along the direction of the linear motion, thereby the stirring-coverage zones of the friction-stir tools form a planar welding zone.

Thus, the present invention has advantages as follows. The present invention can joint contiguous surfaces of stacked metallic boards in a planar manner, so as to reduce gaps between metallic boards for enhancing welding strength and thermal conductivity efficiency. The present invention further can accelerate the speed of welding stacked metallic boards.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a perspective view of a friction stir welding device used to weld stacked metallic boards of the present invention;

FIG. 2 is a top view of a friction stir welding device of the present invention;

FIG. 3 is a cross-sectional view of the process used to weld the stacked metallic boards of the present invention;

FIG. 4 is a top view of stacked metallic boards of the present invention;

FIG. 5 is top view of a friction stir welding device of a second embodiment according to the present invention.

FIG. 6 is another cross-sectional view of stacked metallic boards being welded according to the present invention;

FIG. 7 is a front view of a friction stir welding device of a third embodiment according to the present invention;

FIG. 8 is a top view of a friction stir welding device of a fourth embodiment according to the present invention;

FIG. 8A is a partial cross-sectional view of FIG. 8 of the present invention;

FIG. 9 to FIG. 11 are top views of the friction stir welding device of the fourth embodiment processing in order according to the present invention; and

FIG. 9A to FIG. 11A are side views of FIG. 9 to FIG. 11 respectively of the present invention.

### DETAILED DESCRIPTION OF THE PREFERRED EMBODIMENTS

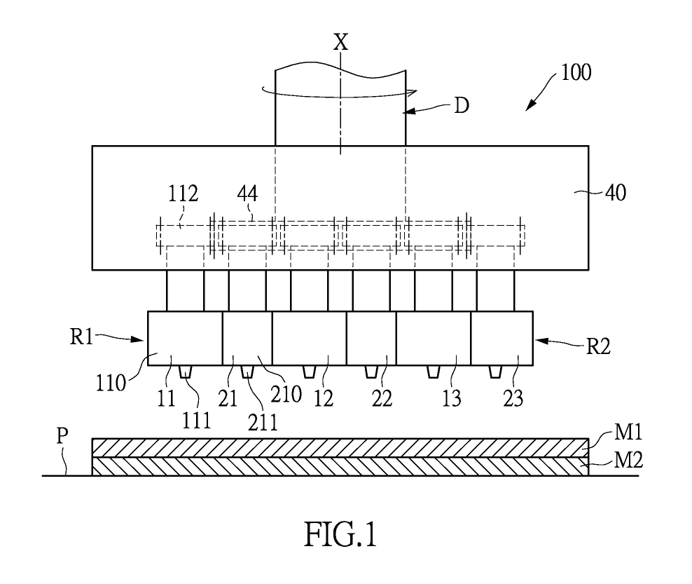

Refer to FIG. 1, which is a perspective view of friction stir welding device used to weld the stacked metallic boards of the present invention. The present invention provides a friction stir welding device 100 for welding two stacked metallic boards M1 and M2, so that the stacked metallic boards (M1 and M2) can be joined together. The friction stir welding device 100 includes a linking seat 40 and a plurality of friction-stir tools 11, 12, 13, 21, 22, 23. The linking seat 40 is defined with a rotational axis-direction X. The rotational axis-direction X is substantially perpendicular to the stacked metallic boards (M1 and M2).

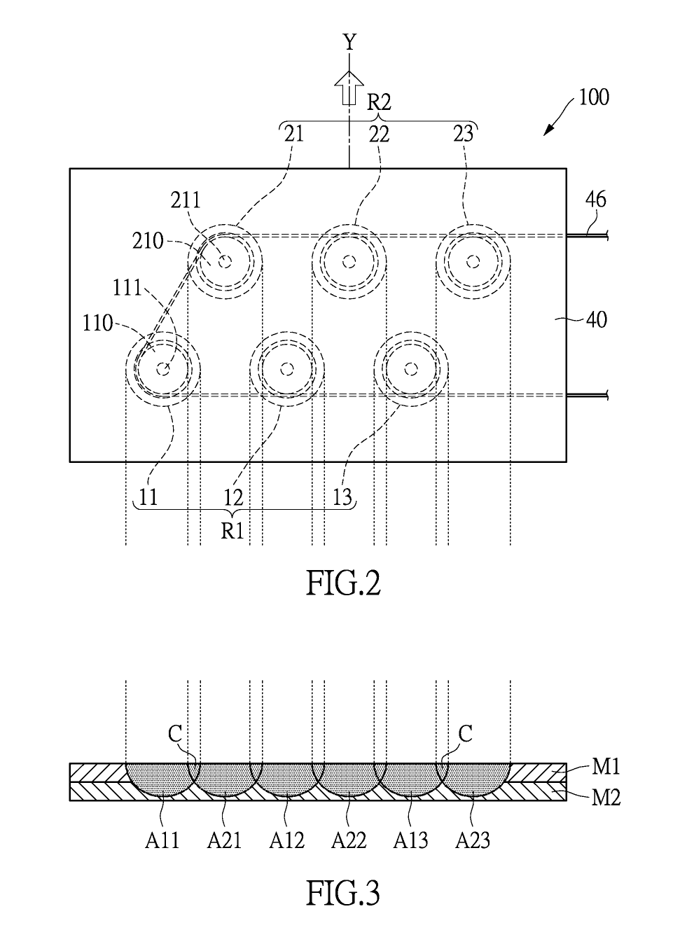

During the welding process, there is relative linear motion between the friction-stir tools 11, 12, 13, 21, 22, 23 and the stacked metallic boards M1, M2. In principle, the stacked metallic boards M1, M2 are rigidly fixed on a backing plate P (or called as an anvil, as shown in FIG. 1). The friction stir welding device 100 is moved linearly, such as the Y-axis as shown in FIG. 2. During the welding process, the friction-stir tools 11, 12, 13, 21, 22, 23 are rotated in high speed, and slide over the metallic board M1 in a linear manner, along a straight line over the metallic board M1.

Refer to FIG. 2, which is a top view of the friction stir welding device of the present invention. In this embodiment, the friction-stir tools 11, 12, 13, 21, 22, 23 are arranged in two rows R1, R2. However, the present invention is not limited thereto, it can include more friction-stir tools, and the quantity of rows can be at least two. To take the friction-stir tools 11 and 21 as example, each of the friction-stir tools 11, 21 has a shoulder portion 110, 210 and a stirring probe 111, 211 protruded from the shoulder portion 110, 210. The friction-stir tools 11, 12, 13, 21, 22, 23 are arranged in parallel to each other in the rotational axis-direction X under the linking seat 40. The friction-stir tools 11, 12, 13, 21, 22, 23 can rotate along the rotational axis-direction X.

Refer to FIG. 3, which is a perspective view of stacked metallic boards of the present invention. To take the friction-stir tools 11 and 21 as an example, the friction-stir tools 11, 21 have stirring probes 111, 211 plugging in the metallic boards M1, M2 for friction and stirring. Heat is generated by friction between the shoulder portions 110, 210 of the friction-stir tools 11, 21 and the surface of metallic boards M1, to make malleability material between the metallic boards M1. The shoulder portions 110, 210 can prevent the malleability material from flowing over and have the function of cleaning the surficial oxidized layer.

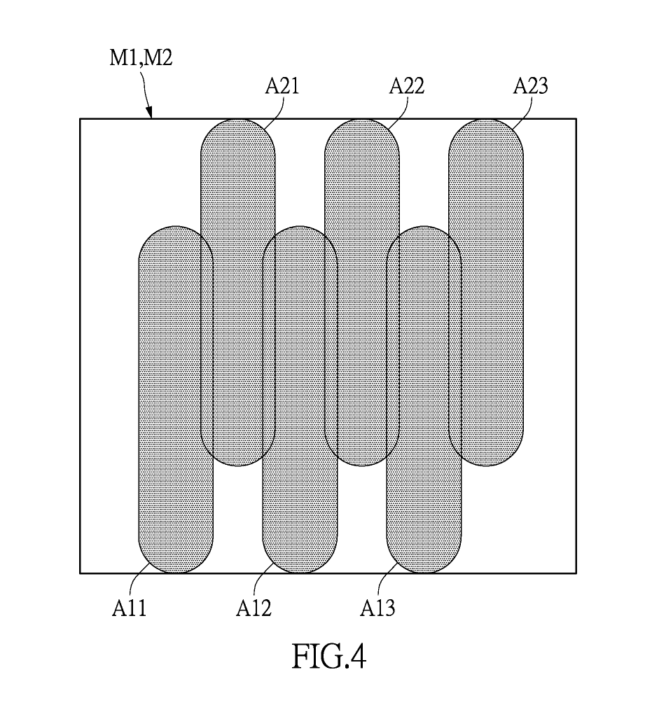

Refer to FIG. 2 and FIG. 3. The stirring-coverage zones A11, A21 by the shoulder portion 110, 210 of the friction-stir tools 11, 12 are overlapped partially along the linear moving direction Y, so that the stirring-coverage zones A11, A21 of the friction-stir tools 11, 21 form a planar welding zone, as shown in FIG. 4. In this embodiment, the friction-stir tools 11, 12, 13, 21, 22, 23 are arranged in two rows R1, R2, and the friction-stir tools of different rows are staggered to each other along the linear moving direction Y. In other words, the friction-stir tools 11, 12, 13 of first row R1 and the friction-stir tools 21, 22, 23 of second row are staggered to each other. From another viewpoint, as shown in FIG. 2, along a traversal cross-sectional surface perpendicular to the friction-stir tools, the stirring-coverage zones A11, A21, A12, A22, A13, A23 of the friction-stir tools 11, 12, 13, 21, 22, 23 along the linear moving direction Y of the friction stir welding device 100 are overlapped partially and connected to a planar-shaped stirring-coverage zone (as shown in FIG. 3 and FIG. 4). In detail, the friction-stir tools 21 of second row R2 and the friction-stir tools 11, 12 of first row R1 are arranged in a staggered manner. The friction-stir tool 22 of second row R2 and the friction-stir tools 12, 13 of first row R1 are arranged in a staggered manner. The friction-stir tool 13 of first row R1 and the friction-stir tools 22 and 23 of second row R2 are arranged in a staggered manner.

Refer to FIG. 3 and FIG. 4. By this arrangement of this embodiment, the shoulder portions of the friction-stir tools 11, 12, 13, 21, 22, 23 at different rows (R1, R2) make the stirring-coverage zones A11, A21, A12, A22, A13, A23 happen from left to right and overlap partially to form many overlapping areas C. In other words, they are overlapped in a zigzag manner to bring forth a planar shaped welding result. As shown in FIG. 2, during the welding process, the friction stir welding device 100 only needs to move one time in the linear moving direction Y. The stacked metallic boards M1, M2 could be formed with a surface-type welding, and do not need to move back and forth. Referring to FIG. 4, because the friction-stir tools 11, 12, 13, 21, 22, 23 are alternating in a front and rear manner, some areas of the stacked metallic boards M1, M2 not welded can be welded by single friction-stir tools, or cut away. In addition, the present invention can further use milling machine (not shown) to mill surfaces of the stirring-coverage zones smooth and level, so that the stacked metallic boards M1, M2 have a flat surface. Another method of the present invention can feed the friction-stir tools separately, which can reduce wasted material and will be described in detail by a later embodiment.

Please refer to FIG. 1. The present invention can apply different ways to drive the friction-stir tools 11, 12, 13, 21, 22, 23 by the linking seat 40. The linking seat 40 could have a gear set 44 to transfer power to the friction-stir tools 11, 12, 13, 21, 22, 23. To take the friction-stir tool 11 as an example, the gear set 44 is engaged with a secondary gear 112 on a top end of the friction-stir tool 11. The linking seat 40 can be connected with a motive spindle D of a multiple spindle vertical milling machine, such as a multi-spindle tool. By connecting the linking seat 40 to a milling machine (not shown, only the motive spindle D is shown), the milling machine can drive the gear set 44, and then bring the friction-stir tools 11, 12, 13, 21, 22, 23 to rotate.

Please refer to FIG. 2. The linking seat 40 can use a chain 46 to transfer motive power to the friction-stir tools 11, 12, 13, 21, 22, 23. The chain 46 connects the friction-stir tools 11, 12, 13, 21, 22, 23 to provide the friction-stir tools 11, 12, 13, 21, 22, 23 motive power for rotating.

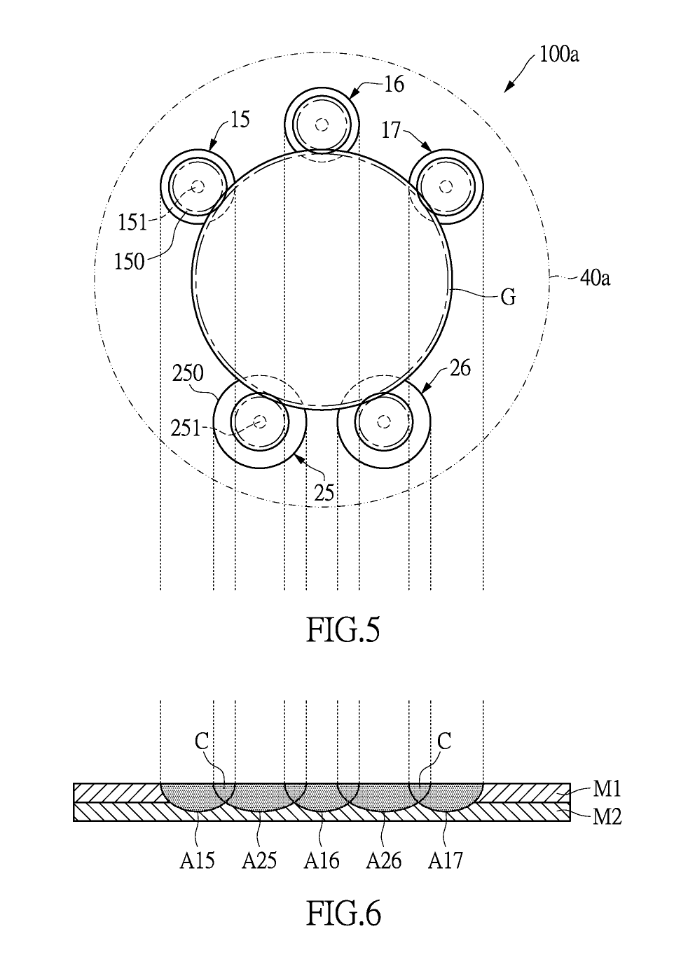

Refer to FIG. 5 and FIG. 6. FIG. 5 is a top view of a friction stir welding device of a second embodiment according to the present invention; FIG. 6 is another cross-sectional view of stacked metallic boards being welded of the present invention. The linking seat of this present invention could be in a different manner. In this embodiment, the friction stir welding device 100a provides a circular linking seat 40a. The friction-stir tools 15, 16, 17, 25, 26 are arranged in a ring shape. The linking seat 40a includes a planetary gear set G to drive the friction-stir tools 15, 16, 17, 25, 26. A supplementary note is that the friction-stir tools 15, 25 have a shoulder portion 150, 250 and a stirring probe 151, 251, respectively. The shoulder portions 150, 250 have different areas to form different stirring-coverage zones A15, A25. In such an arrangement, the friction-stir tools 25, 26 provide larger stirring-coverage zones A25, A26 and smaller stirring-coverage zones A15, A16, A17, which are partially overlapped. The distances between the friction-stir tools 15, 16, 17 can be conveniently arranged according to requirements.

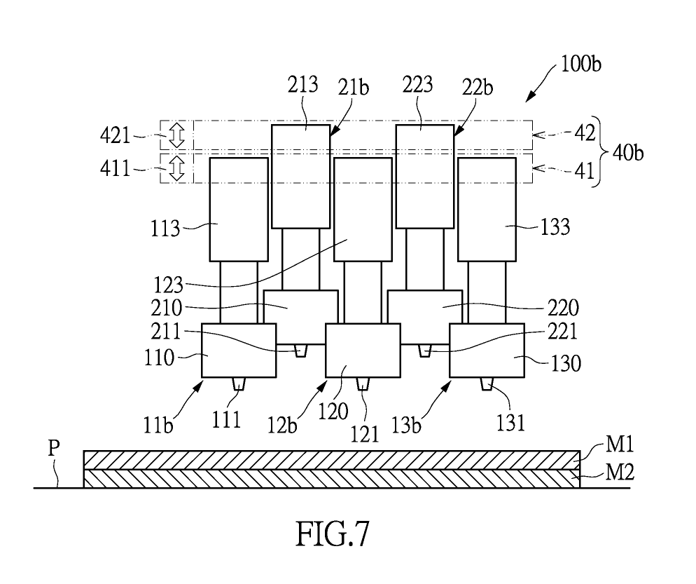

Refer to FIG. 7, which is a front view of a friction stir welding device of a third embodiment according to the present invention. This embodiment illustrates that the present invention could be designed to provide elevatable friction-stir tools. In this embodiment, the friction stir welding device 100b includes a linking seat 40b, which has two attachment mechanisms 41, 42. The two attachment mechanisms 41, 42 correspondingly retain the two rows of friction-stir tools 11b, 12b, 13b and 21b, 22b. Each friction-stir tool 11b, 12b, 13b, 21b, 22b has a motive unit 113, 123, 133, 213, 223, such as a motor, to drive the shoulder portion 110, 120, 130, 210, 220 and the stirring probe 111, 121, 131, 211, 221. The attachment mechanisms 41, 42 have an elevating device 411 and 421 disposed at one side thereof, to lift or lower the attachment mechanisms 41, 42. By this arrangement, the elevatable friction-stir tools can mend the portions which are not welded in FIG. 4. For example, after the friction-stir tools 11b, 12b, 13b traverse in a distance, the attachment mechanisms 42 and the friction-stir tools 21b, 22b are lowered by the elevating device 421 to weld the stacked metallic boards M1, M2 from their edges. This embodiment is not limited by the above-mentioned embodiment. The number of the attachment mechanism can be at least two, and at least one attachment mechanism has an elevating device at one side thereof.

The present invention, based on the above-mentioned friction stir welding device, provides a method of friction stir welding, for welding two stacked metallic boards M1, M2, as shown in FIG. 1 to FIG. 3, which includes steps as follows.

A linking seat 40 is provided, and a rotational axis-direction X is defined on the linking seat 40.

A plurality of friction-stir tools 11, 12, 13, 21, 22, 23 is provided, and the friction-stir tools 11, 12, 13, 21, 22, 23 are rotatably arranged over the linking seat 40 along the rotational axis-direction X in parallel manner. Each of the friction-stir tools 11, 12, 13, 21, 22, 23 has a shoulder portion (110, 210, and others not labelled with a number) and a stirring probe (111, 211, and others not labelled with a number) protruded from the shoulder portion.

Following, making a relative linear motion between the friction-stir tools 11, 12, 13, 21, 22,23 and the stacked metallic boards M1, M2.

Then, a plurality of stirring-coverage zones A11, A21, A12, A22, A13, A23 are formed in the linear moving direction Y by the shoulder portion (110, 210, and others not labelled with a number) of the friction-stir tools 11, 12, 13, 21, 22, 23 being overlapped partially. Therefore, the stirring-coverage zones A11, A21, A12, A22, A13, A23 form a welding area in a planar manner, as shown in FIG. 4.

The friction-stir tools 11, 12, 13, 21, 22, 23 can be arranged as follows. The friction-stir tools 11, 12, 13, 21, 22, 23 can be arranged into at least two rows R1, R2. The friction-stir tools 11, 12, 13, 21, 22, 23 at different rows are staggered to each other, so that the stirring-coverage zones (A11, A21, A12, A22, A13, A23), which are formed by the shoulder portions (110, 210, and others not labelled with a number) of the friction-stir tools 11, 12, 13, 21, 22, 23, are overlapped partially to each other. Alternatively, the friction-stir tools can be arranged in a ring shape according to FIG. 5. In addition, the friction-stir tools can be arranged according to FIG. 7, which are equipped with a linking seat 40b. The linking seat 40b includes at least one elevatable attachment mechanism to lift or lower the friction-stir tools.

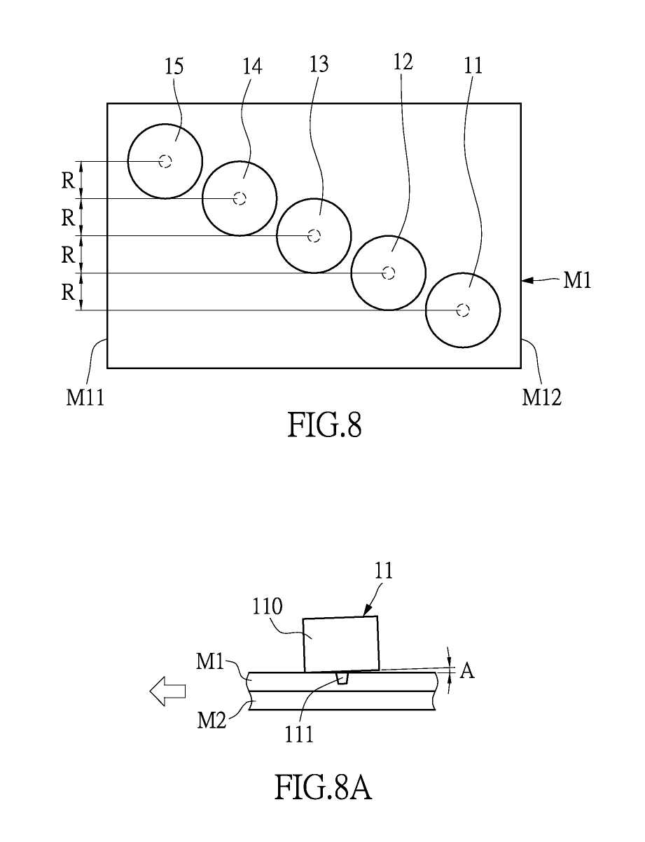

Refer to FIG. 8, which is another top view to show the friction-stir tools in another arrangement of the present invention. This embodiment is shown with five friction-stir tools 11, 12, 13, 14, 15, and the friction-stir tools 11, 12, 13, 14, 15 are arranged in a dislocation manner. In other words, they are arranged on an oblique line relative to a front edge M11 and a rear edge M12 of the metallic boards M1 (the metallic board M2 is overlapped under the metallic board M1). Each of the friction-stir tools 11, 12, 13, 14, 15 has a central point. The distance between the central points along the front edge M11 of the metallic boards M1 preferably is equal to a radius R of the friction-stir tools. For example, if the friction-stir tool has a diameter of 30 mm, the distance between the friction-stir tools 11 and the friction-stir tools 12 is 15 mm.

Refer to FIG. 8A, which is a side view of friction-stir tools to process welding of the present invention. When the five friction-stir tools 11, 12, 13, 14, 15 are processing (or termed “feed”) frictional-stir welding, they can be fed simultaneously, that is contacting the metallic boards M1 and M2 at the same time. In this embodiment, the friction-stir tool for processing frictional-stirring welding preferably is slanted relative to the top surface of the metallic board M1. To take the friction-stir tool 11 as an example in this figure, the bottom surface of the shoulder portion 110 of the friction-stir tool 11 is preferably slanted and raised with a slanting angle A opposite to the motion direction of the metallic boards M1 and M2. The slanting angle A can be between 1 degree and 5 degrees, and preferably is about 2 degrees. This arrangement has the advantages of reducing resistance force when the friction-stir tools are fed to contact the metallic boards M1.

In addition, the rotation directions of two neighbor friction-stir tools (for example, 11 and 12) can be opposite, which can reduce the lateral component force and axial loading.

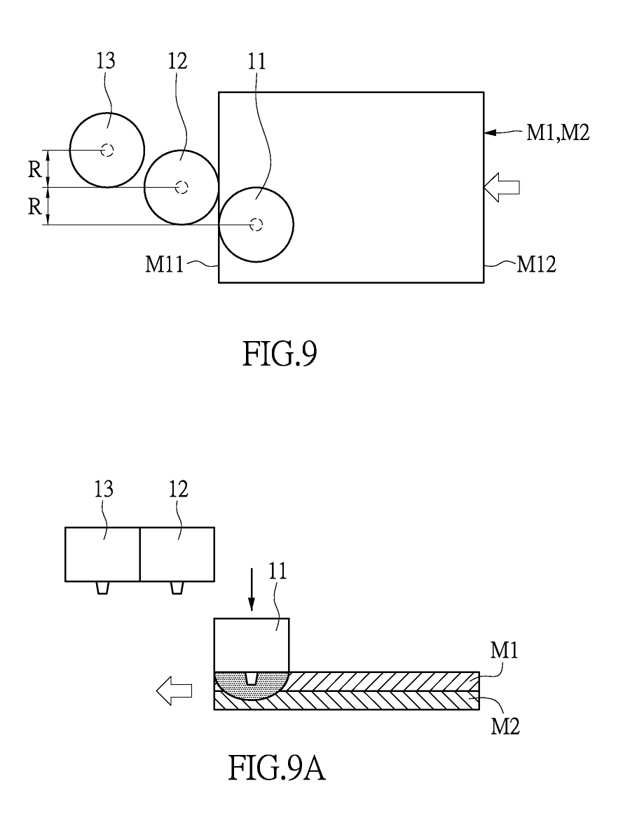

Refer to FIG. 9 to FIG. 11A. The friction-stir tools of the present invention preferably can be lifted or lowered independently. The friction-stir tools are separated in order in a predetermined time to contact the metallic boards M1 and M2 for stir welding. Take the friction-stir tools 11, 12, 13 as an example as follows. Each friction-stir tool of this embodiment can be equipped with a single shaft having independent power and elevating independently.

As shown in FIG. 9 and FIG. 9A, the metallic boards M1 and M2 move leftward in the figures, and the metallic boards M1 and M2 arrive at the bottom of the friction-stir tool 11. The friction-stir tool 11 are fed to contact the top surface of metallic boards M1 for frictional-stirring.

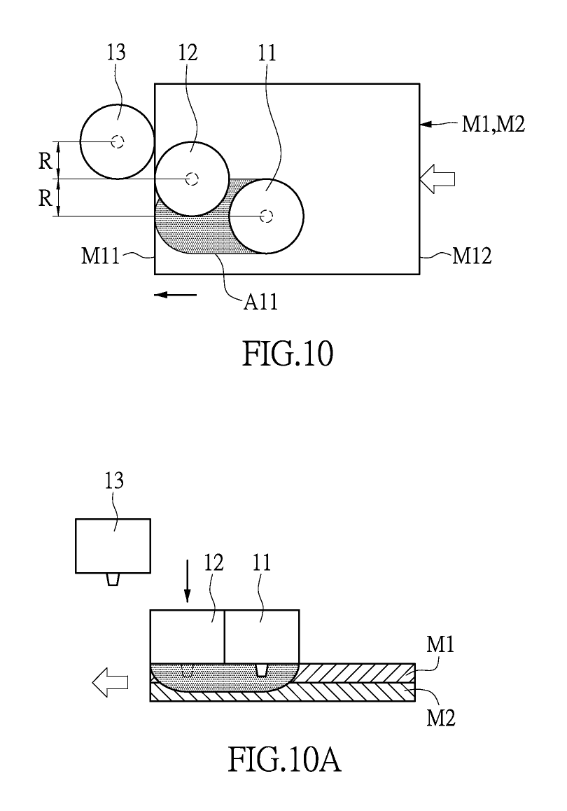

Refer to FIG. 10 and FIG. 10A. The metallic boards M1 and M2 continue to move leftward to underneath of the friction-stir tool 12. And then, the friction-stir tool 12 is fed to contact the top surface of the metallic boards M1 for frictional-stirring. As shown in FIG. 10, the friction-stir tool 11 and the friction-stir tool 12 begin the frictional-stirring from the front edge M11 of the metallic boards M1. The stirring-coverage zones A11, A21 are established from and aligned to the front edge M11 of the metallic boards M1.

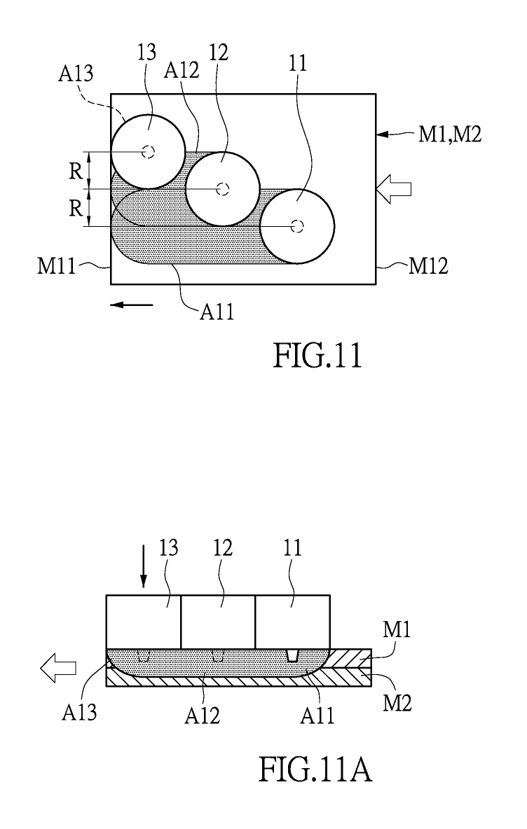

Refer to FIG. 11 and FIG. 11A. The metallic boards M1 and M2 continue to move leftward to underneath of the friction-stir tool 13. Then, the friction-stir tool 13 is fed to contact the top surface of the metallic board M1 for frictional-stirring. As shown in FIG. 11, the friction-stir tool 13 and the friction-stir tools 11, 12 begin the frictional-stirring from the front edge M11 of the metallic board M1. The stirring-coverage zones A11, A21, A13 are established from and aligned to the front edge M11 of the metallic boards M1. The metallic boards M1 and M2 continue to move leftward, and the stirring-coverage zones A11, A21, A13 are fully covered from the front edge M11 to the rear edge M12, without additional cutting work. This embodiment can reduce a waste of redundant material by feeding the friction-stir tools individually.

The present invention has characteristics and functions as follows. The contiguous surfaces of stacked metallic boards M1, M2 can be welded in a planar manner, so as to reduce gaps between the metallic boards, and enhance welding strength and thermal conductivity. Especially, the present invention can accelerate the welding speed of stacked metallic boards M1, M2. This can save much time compared with the conventional friction-stirring in a reciprocating zigzag-shaped manner. In addition, the present invention can ensure the stirring-coverage zones overlap each other, with an assurance of welding quality.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A friction stir welding device, for welding stacked metallic boards, the friction stir welding device comprising:
a linking seat, defined with a rotational axis-direction; and
a plurality of friction-stir tools, each of the friction-stir tools has a shoulder portion and a stirring probe protruded from the shoulder portion, wherein the friction-stir tools are rotatably arranged in the rotational axis-direction under the linking seat, the friction-stir tools rotating in the rotational axis-direction;
wherein a relative linear motion happens between the friction-stir tools and the stacked metallic boards, and the shoulder portion of the friction-stir tools produces stirring-coverage zones partially overlapped in the linear moving direction, so that the stirring-coverage zones by the friction-stir tools forms a planar welding zone.

2. The friction stir welding device as claimed in claim 1, wherein the friction-stir tools are arranged at least two rows, and the friction-stir tools at different rows are staggered related to each other, wherein the stirring-coverage zones formed by the shoulder portions at different rows of the friction-stir tools are overlapped partially to each other.

3. The friction stir welding device as claimed in claim 2, wherein the linking seat includes at least two attachment mechanisms, the at least two attachment mechanisms hold the at least two friction-stir tools correspondingly, at least one of the attachment mechanisms has one side equipped with an elevating device for lifting or lowering the friction-stir tools.

4. The friction stir welding device as claimed in claim 1, wherein the linking seat includes a gear set, each of the friction-stir tools has a secondary gear formed at a top thereof, the gear set is engaged with the secondary gears.

5. The friction stir welding device as claimed in claim 4, wherein the linking seat is connected to a milling machine, and the gear set is driven by the milling machine.

6. The friction stir welding device as claimed in claim 1, wherein the linking seat has a chain, the chain connects the friction-stir tools to provide motive power for driving the friction-stir tools.

7. The friction stir welding device as claimed in claim 1, wherein the friction-stir tools are arranged in a ring shape.

8. The friction stir welding device as claimed in claim 7, wherein the linking seat includes a planetary gear set for driving the friction-stir tools.

9. The friction stir welding device as claimed in claim 7, wherein the shoulder portions of the friction-stir tools have different areas to form the stirring-coverage zones with different areas.

10. The friction stir welding device as claimed in claim 1, wherein the friction-stir tools are arranged in a differential manner, and are arranged along an edge of the metallic boards in an oblique line, a distance between two central points of the friction-stir tools along the edge of the metallic boards is equal to a radius of the friction-stir tools.

11. A method of friction stir welding, used to weld stacked metallic boards, comprising steps as follows:
providing a linking seat, and defining a rotational axis-direction in the linking seat;
providing a plurality of friction-stir tools, and connecting the friction-stir tools to the linking seat in a parallel manner and being rotatable in the rotational axis-direction, wherein each of friction-stir tools has a shoulder portion and a stirring probe protruded from the shoulder portion;
making relative linear motions between the friction-stir tools and the stacked metallic boards; and
arranging stirring-coverage zones produced by the shoulder portions of the friction-stir tools being overlapped partially to each other along the direction of the linear motion, thereby the stirring-coverage zones of the friction-stir tools form a planar welding zone.

12. The method of friction stir welding as claimed in claim 11, wherein the friction-stir tools are arranged as follows:
arranging the friction-stir tools in at least two rows;
making the friction-stir tools of different rows to stagger to each other, so that the stirring-coverage zones produced by the shoulder portions of the friction-stir tools at different rows are overlapped partially.

13. The method of friction stir welding as claimed in claim 11, further comprising a step of using a milling machine to mill surfaces of the stirring-coverage zones smooth and level.

14. The method of friction stir welding as claimed in claim 11, wherein the two neighbor friction-stir tools have opposite rotating directions to lower lateral forces and axial loading.
